(19) United States
(12) Patent Application Publication
(10) Pub. No.: US 2011/0229608 A1
(43) Pub. Date: Sep. 22, 2011

(54) FROZEN CONFECTIONERY PRODUCT AND AN APPARATUS AND METHOD OF MANUFACTURE THEREOF

(75) Inventors: Alain Marcel Alexis Plessier, Bresles (FR); Wolfgang Gaeng, Le Mont St. Adrien (FR); Vijayanta Kapil, Mareil Marly (FR)

(73) Assignee: NESTEC S.A., Vevey (CH)

(21) Appl. No.: 13/132,689

(22) PCT Filed: Nov. 18, 2009
(86) PCT No.: PCT/EP2009/065345

§ 371 Date: Jun. 3, 2011

(30) Foreign Application Priority Data
Dec. 5, 2008 (EP) 08170787.9

(51) Int. Cl. A23G 9/48; A23G 9/04

(52) U.S. Cl. 426/101; 426/100; 426/289; 99/485

(57) ABSTRACT

The present invention relates to a frozen confectionery product (1, 20) having a conical shape and comprising a core filling consisting of a first component (9, 22) being coextruded with a second component (4, 23), said second component (4, 23) surrounding said first component (9, 22). Both components consist of a frozen confection. The present invention further relates to an apparatus (11) and a method for manufacture thereof.

The present invention relates to frozen confectionery products. Specifically, the present invention relates to frozen confectionery products having a conical shape. It also relates to a method and an apparatus for manufacture of such products.

Many frozen confectionery products or frozen confectionery products are known. Increasingly, there is a consumer demand for composite products formed from different edible materials in complementary combinations. One major task is to make the products more nutritionally attractive to the consumers, e.g. by reducing the overall calories of an edible product without compromising the product volume.

When producing frozen confectionery products formed from different edible materials, however, significant production and packaging difficulties involved in the integration and package of these materials in various shapes and sizes arise. It is therefore highly desirable to produce interesting new products in a consistent and cost effective manner.

In prior art, different frozen confectionery products comprising two or more coextruded components are known. The known products have a round or cylindrical shape and are produced by providing a continuous coextruded roll or belt, which is cut into individual portions by appropriate cutting mechanisms.

A frozen confectionery product of the known type is shown in document U.S. Pat. No. 5,888,567. This document shows articles of frozen confectionery which provide a spiral pattern and are obtained by extruding frozen confectionery materials through a plurality of nozzle member tubes which are aligned successively. The apparatus of U.S. Pat. No. 5,888,567 is dedicated to do continuous coextrusion with a fixed position, i.e. either horizontal extrusion for cakes or vertical coextrusion for sticks in connection with a cutting device on a continuous belt.

Document US 2005 214 416 A discloses the extrusion of ice cream comprising one or more edible components in different shapes, e.g. round or conical, using variable opening diaphragms. Therefore, an extruded roll of frozen confectionery is fed to a forming head with diaphragms, such that the frozen confectionery is directed alternately to one of the diaphragms. The individual portions are formed and cut from the roll by the opening and closing of the diaphragms.

The prior art thus provides frozen confectionery products comprising different coextruded edible materials, but is limited to cylindrical products being produced in a continuous manufacturing process.

There is therefore the demand for new frozen confectionery products and new frozen confectionery products being simple and cost-effective in production and attractive to the consumers.

It is therefore the objective problem of the present invention to improve the prior art or to provide at least an alternative to prior art.

This object is solved by the independent claims.

Further features and embodiments are subject matter of the dependent claims.

Further features, advantages and objects of the present invention will become evident by means of the figures of the enclosed drawings as well as by the following detailed explanation of illustrative—only embodiments of the present invention.

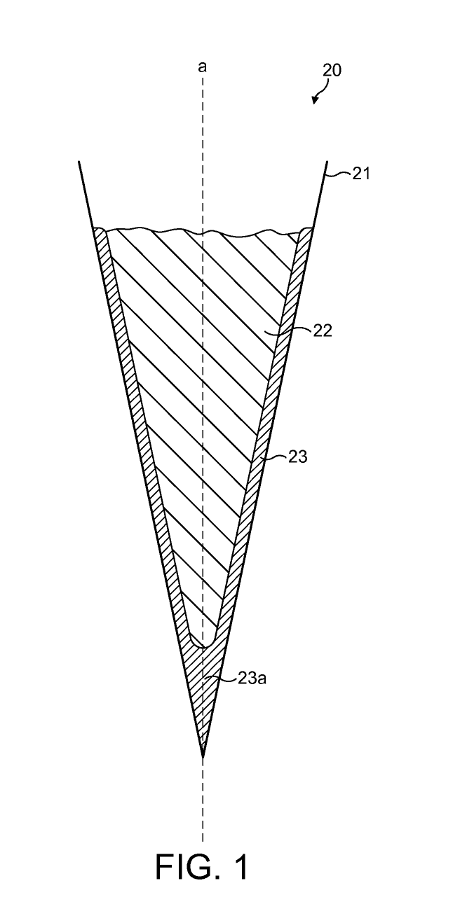

FIG. 1 shows a longitudinal cross section of a frozen confectionery product according to the present invention,

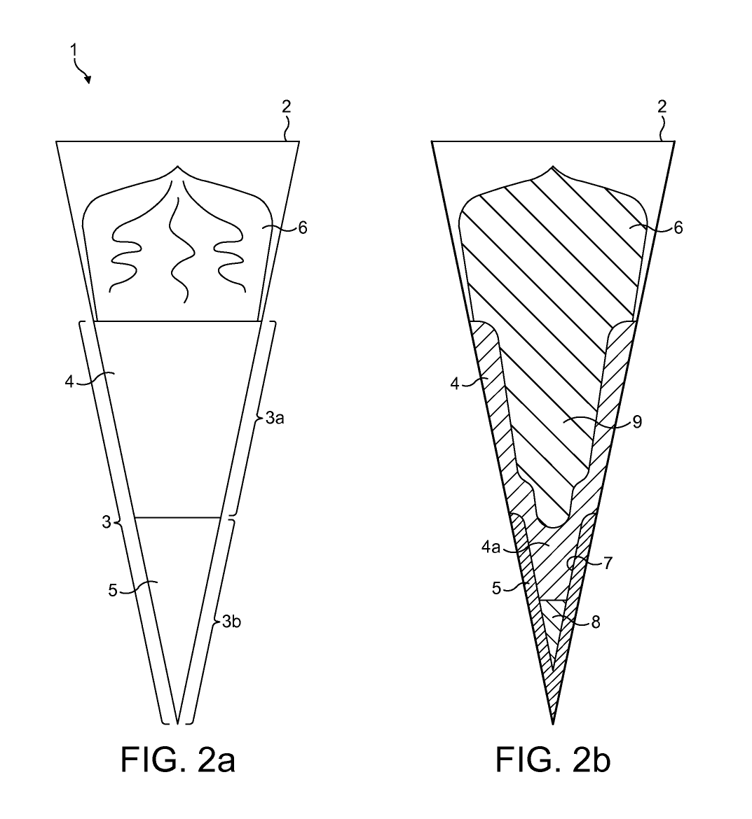

FIG. 2a shows a frozen confectionery product according to the present invention,

FIG. 2b shows a longitudinal cross section of the frozen confectionery product of FIG. 2a,

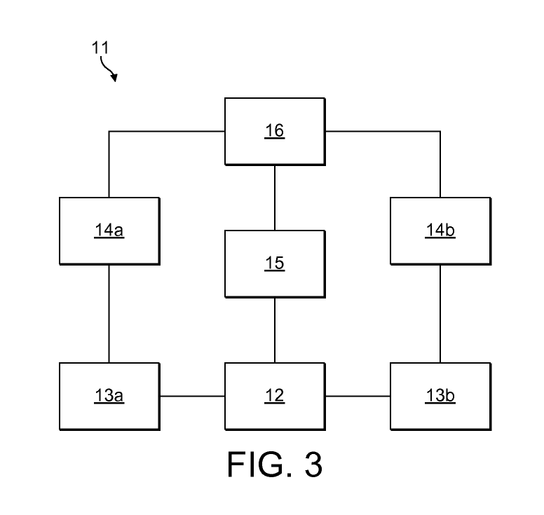

FIG. 3 shows a schematic block diagram of an apparatus for manufacturing a frozen confectionery according to the present invention,

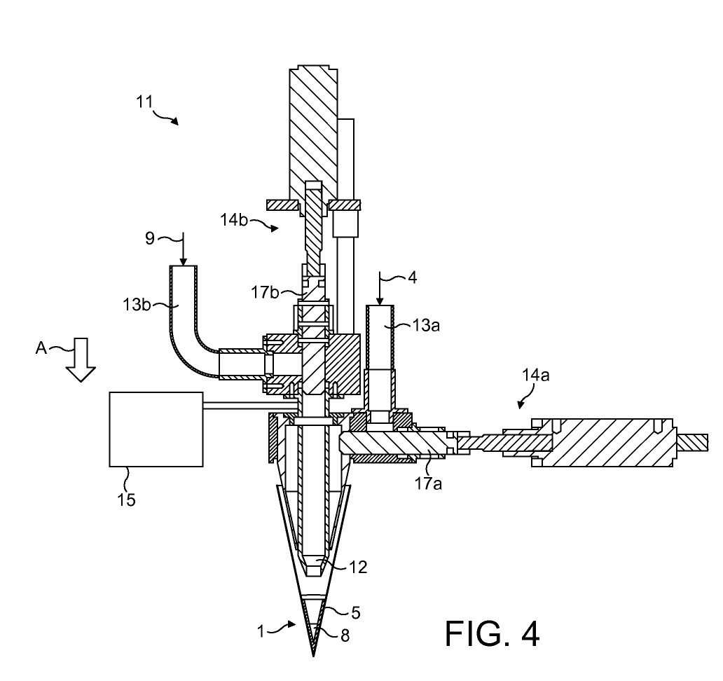

FIGS. 4 to 8 show an apparatus for producing the frozen confectionery product according to the present invention in different production cycles,

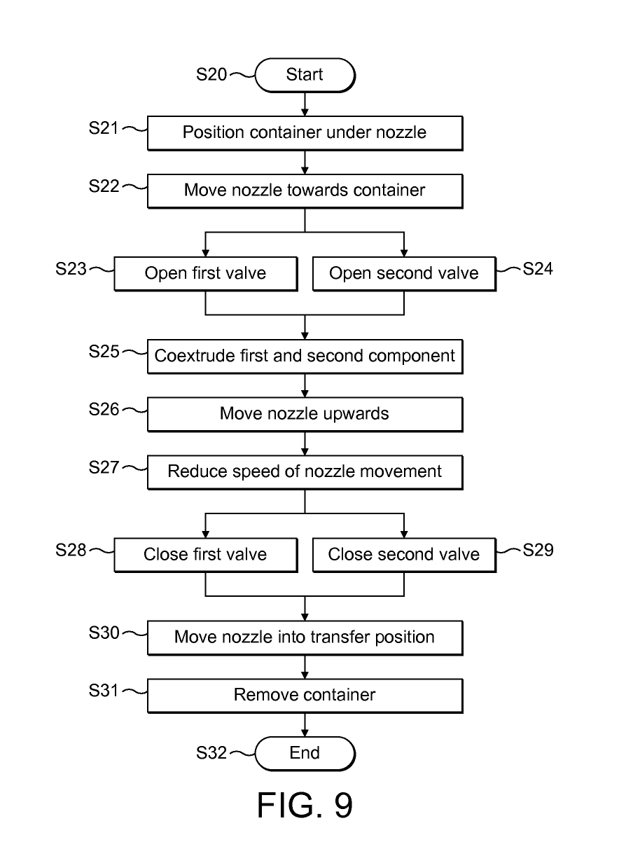

FIG. 9 is a flow chart showing schematically the steps of the method for manufacturing a frozen confectionery product according to a first embodiment of the present invention, and

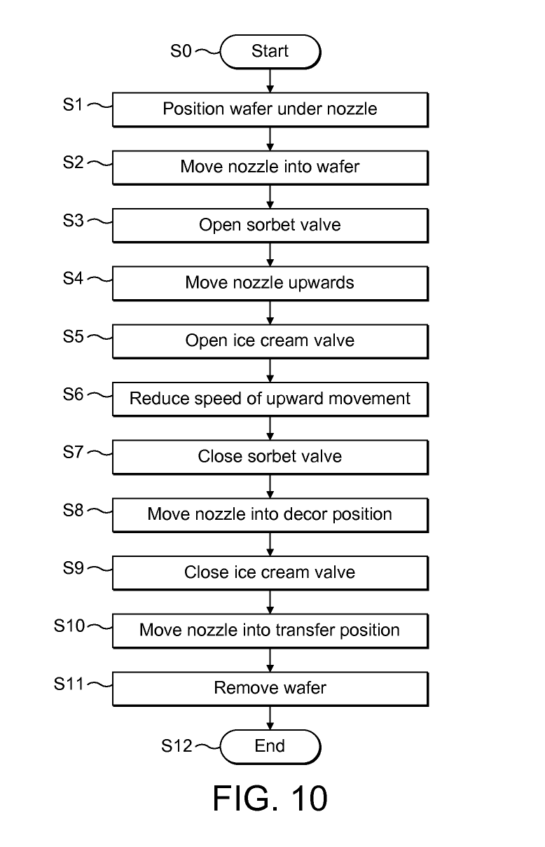

FIG. 10 is a flow chart showing schematically the steps of the method for manufacturing a frozen confectionery according to a second embodiment of the present invention.

FIG. 1 shows a longitudinal cross section of a frozen confectionery product 20 according to a first embodiment of the present invention. The frozen confectionery product 20 comprises a container 21, which is either edible itself, e.g. a wafer, or removable from the edible materials, e.g. a sleeve or another type of non-edible container.

The part of the frozen confectionery product within the container 21 comprises at least two types of frozen confection, which are referred to as first component 22 and second component 23. During the manufacturing process, the two components are semi-solid, viscous and extrudable.

The frozen confectionery product has a conical shape as shown in FIG. 1, i.e. a shape which is substantially circular in cross section and which decreases or increases in diameter.

The frozen confectionery product 20 has a longitudinal extension. The frozen confectionery product preferably is substantially symmetrical with respect to a central axis a extending into the longitudinal direction.

The first component 22 and the second component 23 are coextruded during production and thereby form a frozen confectionery product 20, which has a core, i.e. an inner part, consisting of the first component 22, and a shell, i.e. an outer part, consisting of the second component 23. That means that the first component 22 surrounds the central axis a and the second component 23 in turn surrounds the first component 22. In other words, the first and second coextruded components 22, 23 are concentric with respect to central axis a. Preferably the core has a substantially conical shape.

Since the frozen confectionery product 20 has a conical form, it might be advantageous to fill the bottom part, i.e. the part of the container 21 having the smallest diameter, with only one single component and to start the coextrusion within the part of the container 21 having a larger diameter. In this case a bottom filling 23a is provided, which in the embodiment shown in FIG. 1 consists of the second component 23. But also a bottom filling 23a consisting of the first component 22 or any other edible material is possible.

FIGS. 2a and 2b show a frozen confectionery product 1 according to a second embodiment the present invention. In the following, the frozen confectionery product in the present application will also be referred to as frozen confectionery having a conical shape, frozen confectionery of the cone type or ice cream cone.

The frozen confectionery product 1 has a conical shape, i.e. it has a substantially circular cross-section and an increasing diameter from one end to the other end. The frozen confectionery is usually packed into a packaging material 2 forming a sleeve made of coated paper or any other suitable material.

The frozen confectionery comprises a shell 3 surrounding at least a part of the frozen confectionery 1. The shell 3 is filled with an aerated frozen confection. Non limiting examples of “aerated frozen confection” within the meaning of the present invention include ice cream, sorbet, sherbet, frozen yoghurt, frozen dairy, soft ice, Mellorine, frozen custard, non-dairy frozen confection, gelato or frozen jelly.

In the following, as an example, the filling will be described as ice cream 9. But it is to be noted that the present invention is not limited to ice cream 9 as filling material and can also comprises any other frozen confection.

In the embodiment of FIG. 2a, part of the ice cream 9 protrudes from the shell 3 and is referred to as decor 6.

In prior art, the shell 3 usually consists of a wafer. According to the second embodiment of the present invention, the frozen confectionery product comprises a shell 3, which at least partly consists of an aerated frozen confection being different from the aerated frozen confection used as a filling component. Again, non limiting examples of “aerated frozen confection” for the shell within the meaning of the present invention include ice cream, sorbet, sherbet, frozen yoghurt, frozen dairy, soft ice, Mellorine, frozen custard, non-dairy frozen confection, gelato or frozen jelly.

In the following, as an example, the shell will be described as comprising sorbet 4. But it is to be noted that the present invention is not limited to the use of sorbet 4 for the shell but any other frozen confection can be used.

As shown in FIG. 2a the shell 3 has two portions 3a, 3b, whereby the first or upper portion 3a consists of sorbet 4 and the second or lower portion 3b consists of a wafer 5. In the present invention the terms “upper” and “upwards” refer to the part of the frozen confectionery 1 having a larger diameter in cross-section and the terms “lower” and “downwards” refer to the part of the frozen confectionery 1 having a smaller diameter in cross-section.

FIG. 2b shows a longitudinal cross section of a frozen confectionery 1 according to the present invention. The lower portion 3b of the shell 3 consists of a wafer 5 and the upper portion 3a of the shell 3 consists of sorbet 4.

Preferably, on the inner side the wafer 5 there is provided a chocolate coating 7 or generally any type of moisture barrier for protecting the wafer 5. At the bottom part of the wafer 5 inside the wafer 5 a chocolate nugget 8 can be provided. The complete shell 3 of the frozen confectionery 1 is constituted by the wafer 5 and by a sorbet 4. The frozen confectionery cone 1 is hereby filled with an ice cream core filling 9 and the part of the ice cream protruding the shell 3 constitutes the decor 6. Of course, it is possible to use sorbet 4 or even a third type of frozen confection for the decor 6 instead of ice cream 9.

According to the present invention, the part of the ice cream 9 within the sorbet shell 4 is hereby coextruded with the sorbet shell 4.

The part of the shell 3 which is constituted by the wafer 5 can either be filled with a sorbet filling 4a as shown in FIG. 2, with ice cream 9 or with a mixture of coextruded sorbet and ice cream 9.

The present invention is not limited to a frozen confectionery having a shell consisting of wafer 5 and sorbet 4 but can also be related to a frozen confectionery having a shell consisting completely of sorbet 4 or generally of any aerated frozen confection.

Besides of its appealing appearance and taste, an advantage of the frozen confectionery product 1 is that it can be easily produced, as will be further apparent from the following description. Furthermore, the frozen confectionery 1 in case of the use of a sorbet shell 4 instead of a wafer 5 has reduced calories without compromising the product volume, which makes the frozen confectionery more attractive to the consumer. Generally, the present invention provides a new type of frozen confectionery product, which can be easily varied and thus allows to provide a broad array of different products.

FIG. 3 shows a schematic block diagram of an apparatus 11 for manufacturing a frozen confectionery according to the present invention. The apparatus 11 comprises a coextrusion nozzle 12 which is adapted to coextrude sorbet 4 and ice cream 9. Hereby, the ice cream 9 or more generally the first component 22 is extruded from an inner part of the nozzle 12 and the sorbet 4 or more generally the second component 23 is extruded from an outer part of the nozzle 12, so that an ice cream core filling 9 within a sorbet shell 4 or more generally a filling of the first component 22 within the second component 23 can be produced.

The apparatus 11 further comprises a first delivery means 13a for delivering the sorbet 4 to the nozzle 12 and comprises a second delivery means 13b for delivering the ice cream 9 to the nozzle 12. The delivery means 13a, 13b can for example be tubes, ducts or the like leading from a respective ice cream or sorbet generator to the nozzle 12.

A first valve 14a is coupled to the first delivery means 13a and adapted to start and stop the delivery of the sorbet 4 to the nozzle 12. Likewise, a second valve 14b is coupled to the second delivery means 13b and adapted to start and stop the delivery of ice cream 9 to the nozzle 12.

The valves 14a, 14b can be any type of mechanism allowing to reversibly start and stop the delivery of ice cream 9 and sorbet 4. For example, the valves can be movable pistons for opening and closing the tube of the delivery means 13a, 13b.

Since a constant pressure within the delivery means 13a, 13b is provided, the ice cream 9 and the sorbet 4 can be constantly delivered to the nozzle 12 in case that the respective valve 14a, 14b is open. On the other hand, when closing one or both valves 14a, 14b the flow of ice cream 9 and/or sorbet 4 to the nozzle 12 is stopped.

With the first valve 14a and the second valve 14b the present invention therefore provides the possibility that the sorbet 4 and the ice cream 9 are not continuously delivered to the nozzle 12. The present invention rather proposes to selectively start and stop the delivery of ice cream 9 and sorbet 4 to the nozzle 12. Thereby a non-continuous production of separate pieces of frozen confectionery 1 becomes possible. Further, since the valves 14a, 14b can be operated independently from each other, a delayed opening and closing of the valves becomes possible. This enables to time the extrusion of the different edible materials in such a way, that at a certain moment during production the two components are coextruded, whereas during another moment only one single component is extruded.

The apparatus 11 further comprises a translation means 15 which serves for moving the nozzle 12 in different directions. Instead of moving only the nozzle 12, the translation means 15 can also be adapted to move the whole apparatus 11 or to move at least parts of the apparatus 11. The translation means 15 is further adapted to change the motion speed of the moved parts. Thereby, the creation of a frozen confectionery product or a frozen confectionery 1 having a conical shape instead of a cylindrical shape becomes possible.

The apparatus 11 further comprises a controller 16 for controlling the operation of the first valve 14a, the second valve 14b and the translation means 15. The controller 16 hereby is adapted to control each of the above-mentioned components separately, i.e. independently of each other. Specifically, the controller 16 provides an accurate timing of the operation of the valves 14a, 14b and the operation of the translation means 15, i.e. the movement of the nozzle 12.

With this specific combination of an accurate timing of the pair of valves and a controlled movement of the nozzle 12 it is possible to manufacture a frozen confectionery according to the present invention in one production step without the need to produce the different parts of the frozen confectionery separately. Thereby a very simple, fast and cost-effective production is possible.

In the following, the production process and the different steps carried out by the apparatus 11 according to the present invention will be explained with reference to FIGS. 4 to 8, where one preferred embodiment of an apparatus 11 according to the present invention is shown. It is however noted, that the present invention is not limited to the shown apparatus 11 but comprises any other type of apparatus 11 allowing to produce a frozen confectionary product according to the invention and provided with a coextrusion nozzle and translation means for moving said nozzle. It is preferred, however, that the apparatus allows a selective control of the flow of the two components and the nozzle movement.

Even if in the following the apparatus will be explained with reference to ice cream 9 and sorbet 4, it is to be noted that the apparatus is not limited to ice cream and sorbet but can be used for the coextrusion of any two components consisting of frozen confectionary being semi-solid, viscous, extrudable and flowable during production. For the filling, in principle any edible and extrudable material can be used such as fruit filling, jam, jelly, or the like.

FIG. 4 shows the start of the dosing of ice cream 9 and sorbet 4. Hereby a wafer 5 with a chocolate nugget 8 has been moved under the nozzle 12 of the apparatus 11. Preferably, the wafer 5 is further surrounded by the packaging material 2 as previously described or by any other type of mould or template having a conical shape and being adapted to receive the coextruded sorbet 4 and ice cream 9.

The sorbet 4 is delivered to the nozzle 12 by the first delivery means 13a and the ice cream 9 is delivered to the nozzle by the second delivery means 13b. The insertion of sorbet 4 and ice cream 9 into the delivery means 13a, 13b, i.e. into the tubes, is indicated by respective arrows pointing towards the first and second delivery means 13a, 13b.

The nozzle 12 or a part of the apparatus 11 or the whole apparatus 11 by the translation means 15 is then moved towards the wafer 5, which in FIG. 4 is shown by an arrow A. The translation means 15 is schematically shown in FIG. 4 and is omitted in the following figures for the sake of clarity.

In the embodiment shown in FIG. 4 the first delivery means 13a, i.e. a tube, delivers the sorbet 4 to the nozzle 12 and the delivery is controlled by the first valve 14a, which in the present embodiment comprises a movable first piston 17a for opening and closing the tube.

Likewise, the second delivery means 13b delivers the ice cream 9 to the nozzle 12 and is controlled by the second valve 14b, which comprises a second piston 17b.

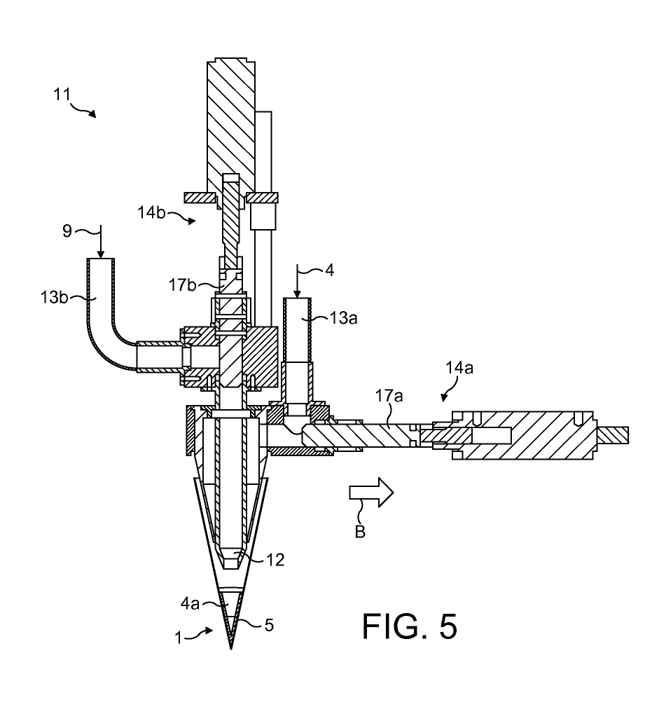

As shown in FIG. 5 in the next step the first valve 14a is opened by moving the first piston 17a which is indicated by arrow B in FIG. 5. This allows the sorbet 4 to flow via the delivery means 13a through the nozzle 12, so that the nozzle 12 extrudes the sorbet 4 into the wafer 5.

At this time the translation means 15 starts to move at least the nozzle 12 upwards so that a continuous filling of the wafer 5 is accomplished.

Alternatively, it is of course possible to start delivery of ice cream 9 first and to fill the bottom part of the wafer 5 with ice cream 9 instead of sorbet 4.

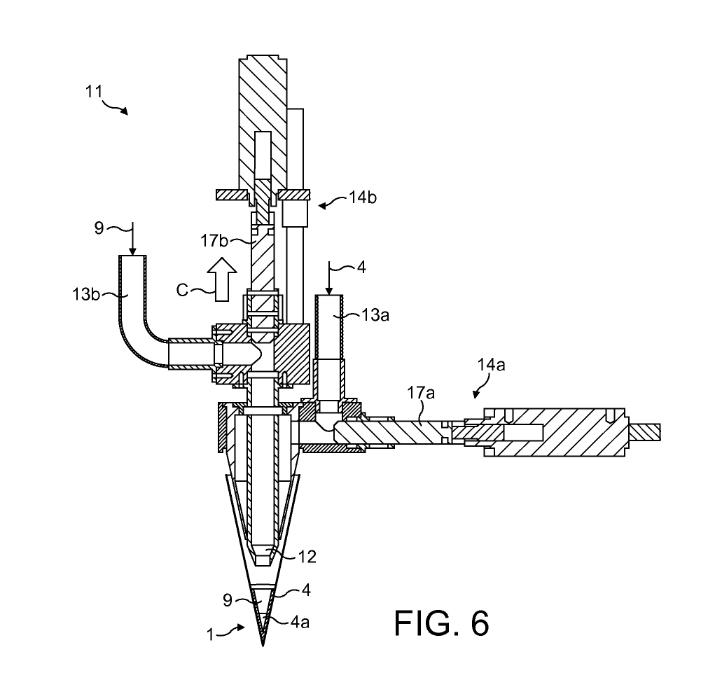

As shown in FIG. 6 after starting the upward movement the second valve 14b is opened by moving the second piston 17b in the direction indicated by arrow C. Thereby the ice cream through the delivery means 13b is delivered to the nozzle 12, which now starts to coextrude an ice cream core filling 9 with the sorbet shell 4.

Since the diameter of the cone to be filled is increasing, the translation means 15 controls the movement of the nozzle 12 in such a way, that the movement speed of the nozzle 12 is constantly reduced. Thereby a continuous creation of an ice cream core filling 9 with a sorbet shell 4 having a conical shape is ensured.

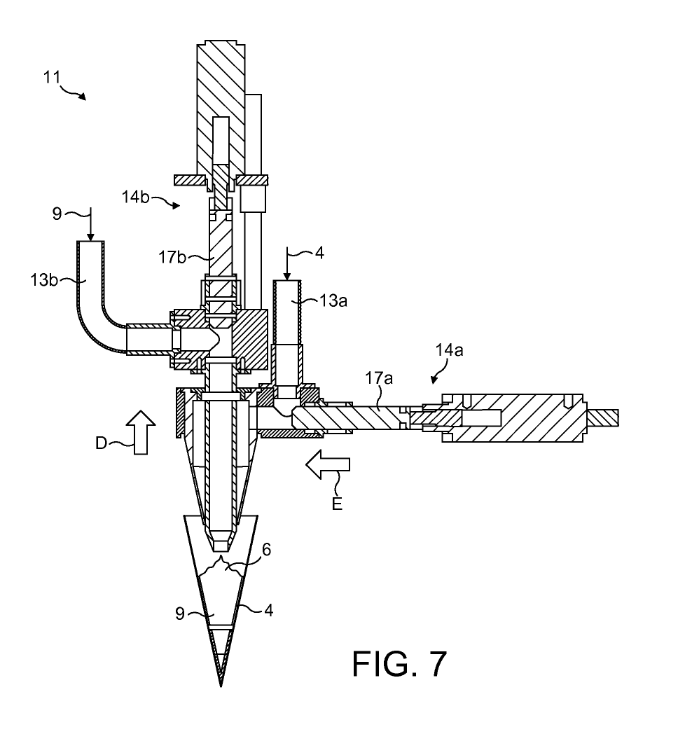

As shown in FIG. 7 after the shell 3 is finished, the first valve 14a is closed, i.e. as shown in FIG. 7 the first piston 17a is moved into direction as indicated by arrow E. Thereby the delivery of the sorbet 4 to the nozzle 12 is stopped. The translation means 15 then moves the nozzle 12 or the whole apparatus 11 into an upwards direction into the position for producing the decor 6. This movement is indicated by arrow D in FIG. 7. In this position then only ice cream 9 is extruded from the nozzle 12 and the decor 6 protruding the shell 3 is created. Alternatively, it is of course possible to provide a decor 6 out of sorbet 4 instead of ice cream 9. In this case, the ice cream delivery is stopped before stopping the delivery of sorbet 4. Alternatively, the decor 6 can also consist of a mixture of ice cream 9 and sorbet 4.

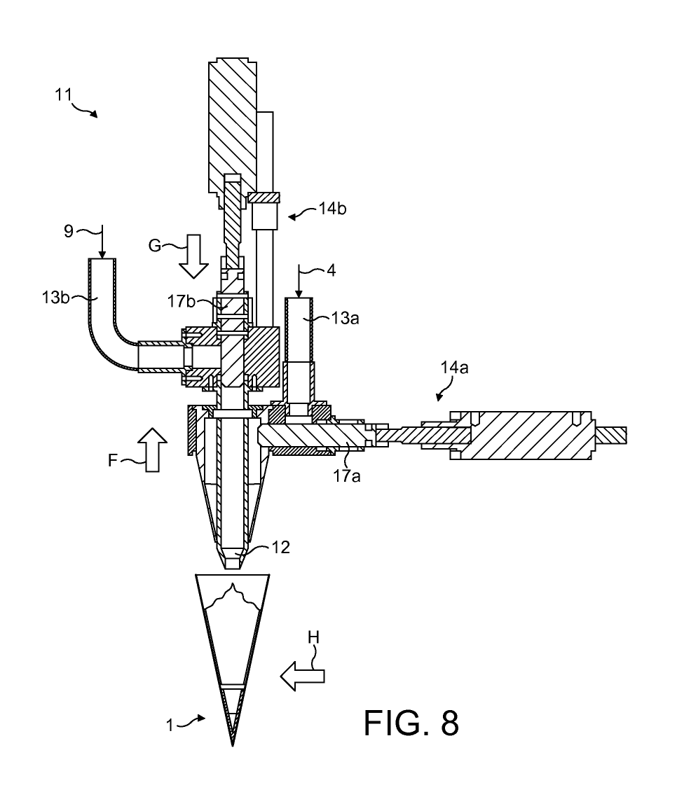

As shown in FIG. 8 in the following step the second valve 14b is closed, which in FIG. 8 is shown by a movement of the second piston 17b in direction indicated with arrow G. Thereby the delivery also of the ice cream 9 is stopped and the frozen confectionery 1 is thus finished. The translation means 15 then moves at least the nozzle 12 or the whole apparatus 11 upwards into the direction indicated by arrow F, so that the nozzle 12 does not further protrude into the frozen confectionery 1. The frozen confectionery 1 can then be removed from under the nozzle 12 by moving the frozen confectionery 1 in the direction as indicated by arrow H. The movement of the wafer is hereby not limited to the movement direction shown in the figure but can have any other direction for freeing the place under the nozzle 12 for the next wafer 5 to be filled.

From this point on again a new wafer 5 can be positioned under the nozzle 12 and the process can again start as shown in FIG. 4.

It is to be noted, that it is also possible to provide a translation means 15 which is adapted to move the wafer 5 instead of the nozzle 12. Alternatively, the wafer 5 as well as the nozzle 12 can be moved. In any case, the translation means 15 according to the present invention is adapted to provide a relative movement between the wafer 5 to be filled and the nozzle 12.

FIG. 9 now gives a general overview of the steps accomplished according to the method for producing a frozen confectionery product according to the embodiment of the present invention which is shown in FIG. 1.

The process starts in step S20. In step S21 the container 21 is positioned under the nozzle 12. In step S22 the nozzle 12 by the translation means 15 is moved towards and/or into the container 21. As already described, alternatively, the container 21 can be moved instead of the nozzle 12 or both, i.e. the container 21 and the nozzle 12 can be moved.

In the following steps, S23 and S24 the first valve 14a and the second valve 14b are opened to start the delivery of the first component 22 and the second component 23 to the nozzle 12. Hereby, either the first valve 14a can be opened before the second valve 14b or vice versa or both valves 14a, 14b can be opened at the same time.

In any case, after both valves are opened, the first and the second component 22, 23 are delivered to the nozzle 12, which then in step S25 coextrudes the first component 22 and the second component 23 thereby creating a filling consisting of one component, which is surrounded by the other component.

In step S26 the nozzle 12 is moved upwards, i.e. away from the container 21. The upward movement can also be started earlier, e.g. during steps S23 and S24.

Since a conical shape frozen confectionery product should be achieved, in the next step S27 the speed of the movement of the nozzle 12 is reduced.

In the next steps S28 and S29, the valves are closed again and the delivery of the components is thus stopped. Again, the order and timing of closing the valves 14a, 14b can be freely chosen in accordance with the desired type of frozen confectionery product.

In the following step S30 the nozzle is moved into the transfer position to allow the final frozen confectionery product 20 to be removed from under the nozzle.

The process ends in step S32 after removing the container in step S31.

FIG. 10 gives again an overview of the steps accomplished according to another method for producing a frozen confectionery according to the present invention, in this case for producing a product according to the second embodiment of the invention shown in FIGS. 2a and 2b.

The process starts in step S0. In step S1 the wafer is positioned under the nozzle. In step S2 the nozzle is lowered into the wafer. In step S3 the sorbet valve is opened and in step S4 the nozzle is moved upwards. In step S5 also the ice cream valve is opened and in step S6 the speed of the upward movement is constantly reduced.

The delivery of ice cream 9 and sorbet 4 to the nozzle is thus started by operating the respective valves. Hereby, in the preferred embodiment of the present invention, the delivery of sorbet 4 is started prior to the delivery of the ice cream 9, so that the wafer filling 4a is constituted of sorbet. But it is also possible to start the delivery of ice cream 9 prior to the delivery of sorbet 4, so that the bottom of the wafer 5 is filled with ice cream 9 instead of sorbet 4. Alternatively or additionally, the bottom of the wafer can be filled with the chocolate nugget 8 or any other edible material. When both valves are open, then the ice cream core filling 9 with the coextruded sorbet shell 4 is created.

In step S7 the sorbet valve is closed in order to finish the production of the shell. In step S8 the nozzle is moved into the decor position and after the decor 6 is created the ice cream valve in step S9 is closed. The delivery of sorbet is thus stopped prior to stopping the delivery of ice cream 9. Thereby, the decor 6 consisting only of ice cream can be created. But is also possible to revert the closing of the valves and to create a decor out of sorbet 4.

In step S10 the nozzle is further moved upwards into the transfer position and in step S11 the wafer is removed. The process ends in step S12.

The present invention thus provides a frozen confectionery product, being simple and cost-effective in production and in the case of the embodiment of FIGS. 2a and 2b being particularly nutritionally attractive to the customer.

The inventive apparatus and method according to the present invention with an independent and reversible control of the valve operation and a control of the movement speed of the nozzle 12 allow producing a variety of products having a conical shape and consisting of several coextruded frozen confections and/or other edible, extrudable materials in one production step. The present invention thus provides a simple cost-effective but at the same very flexible manufacturing apparatus and method.

The present invention thereby improves the prior art, since the present invention is not limited to continuously formed cylindrical frozen confectionery products, but allows to form individual products of coextruded materials having a conical shape.

It is to be noted that the present invention is not limited to the shown embodiments. It is further to be noted that all features, components and/or process steps described with reference to one embodiment can also be incorporated into any other described embodiment where appropriate.

### REFERENCE SIGNS

(1) Frozen confectionery product
(2) Packaging material
(3) Shell
(3a) Upper shell portion
(3b) Lower shell portion
(4) Sorbet
(4a) Wafer filling
(5) Wafer
(6) Decor
(7) Chocolate coating
(8) Chocolate nugget
(9) Ice cream
(11) Apparatus
(12) Nozzle
(13a) First delivery means
(13b) Second delivery means
(14a) First Valve
(14a) Second valve
(15) Translation means
(16) Controller
(17a) First piston
(17b) Second piston
(20) Frozen confectionery product
(21) Container
(22) First component
(23) Second component
(23a) Bottom filling

1. Frozen confectionery product having a conical shape comprising a core filling comprising a first component having a first type of frozen confection that is coextruded with a second component, the second component comprising a second type of frozen confection and being concentric to the first component.

2. Frozen confectionery product according to claim 1, wherein the first component and the second component are selected from the group consisting of ice cream, sorbet, sherbet, frozen yoghurt, frozen dairy, soft ice, Mellorine, frozen custard, non-dairy frozen confection, gelato, frozen jelly, fruit filling, jam and jelly.

3. Frozen confectionery product according to claim 1, wherein the second component forms a shell, and the first and second component comprise a first and second type of aerated frozen confection, respectively.

4. Frozen confectionery product according to claim 1,
wherein the second component is a portion of a shell having two portions, and
the other portion of the shell comprises a wafer.

5. Frozen confectionery product according to claim 1,
wherein the core filling has a substantially conical shape.

6. Apparatus for manufacturing a frozen confectionery product comprising
a nozzle for coextruding a first component and a second component; and
a translation member for moving the nozzle at variable motion speed.

7. Apparatus according to claim 6, comprising
first and second delivery member for delivering the first component and the second component to the nozzle; and
first and second valves coupled to the respective delivery member for controlling the duration of delivery of the first component and the second component to the nozzle.

8. Apparatus according to claim 7, comprising a controller for independently controlling the operation of the first valve, of the second valve and of the translation member.

9. Method for manufacturing a frozen confectionery product according to claim 1, comprising the steps of:
coextruding a first component and a second component by a coextrusion nozzle, and
moving the nozzle at variable motion speed during the coextrusion step.

10. Method according to claim 9, further comprising the step of delivering the first component and the second component to the nozzle.

11. Method according to claim 10, comprising the steps of:
starting the delivery of the second component to the nozzle by operating a first valve and
starting the delivery of first component to the nozzle by operating a second valve.

12. Method according to claim 11, wherein the delivery of the first component and the second component is started at different times.

13. Method according to claim 9, comprising the step of
moving the nozzle during the step of co-extruding in a direction away from the co-extruded first component and second component.

14. Method according to claim 13, comprising the step of
constantly reducing the motion speed of the nozzle during the moving step.

15. Method according to claim 10, comprising the step of
stopping the delivery of the second component to the nozzle by operating the first valve and
stopping the delivery of the second component to the nozzle by operating the second valve.

16. Method according to claim 15, wherein the delivery of the first component and the second component is stopped at different times.
